(19) United States
(12) Patent Application Publication
(10) Pub. No.: US 2017/0282477 A1
(43) Pub. Date: Oct. 5, 2017

(54) ROTARY PRESS AND METHOD FOR SETTING UP AND OPERATING A ROTARY PRESS

(71) Applicant: Fette Compacting GmbH, Schwarzenbek (DE)

(72) Inventors: Hüseyin Ozcoban, Hamburg (DE); Ingo Schmidt, Schwarzenbek (DE); Werner Seifert, Wentorf (DE); Matthias Dederichs, Hambrug (DE)

(21) Appl. No.: 15/472,856

(22) Filed: Mar. 29, 2017

(30) Foreign Application Priority Data
Mar. 29, 2016 (DE) 102016105685.5

(51) Int. Cl. B30B 11/00; B30B 15/30; G01F 23/292; B30B 11/08

(52) U.S. Cl. CPC B30B 11/005; B30B 11/08; B30B 15/302; G01F 23/292

(57) ABSTRACT

A rotary press comprises a rotor that can be rotated by a rotary drive. The rotor has an upper punch guide for upper press punches and a lower punch guide for lower press punches and a die plate arranged between the punch guides. The upper and lower press punches are configured interact with cavities of the die plate. A filling device loads filling material into cavities of the die plate and at least one measuring device coupled to the filling device for monitoring the availability of the filling material in the filling device. The rotary press further includes at least one upper pressing device and at least one lower pressing device that are configured to interact with the upper press punches and the lower press punches to press the filling material in the cavities of the die plate into a pellet. An ejection device is configured to eject the pellets. wherein at least one measuring device is arranged on or in the filling device for monitoring the availability of the filling material in the filling device.

### CROSS REFERENCE TO RELATED INVENTION

This application is based upon and claims priority to, under relevant sections of 35 U.S.C. §119, German Patent Application No. 10 2016 105 685.5, filed Mar. 29, 2016, the entire contents of which are hereby incorporated by reference.

### BACKGROUND

The invention relates to a rotary press comprising a rotor that can be rotated by means of a rotary drive, wherein the rotor has an upper punch guide for upper press punches, a lower punch guide for lower press punches, and a die plate arranged between the punch guides. The press punches interact with cavities of the die plate. A filling device loads filling material into the cavities of the die plate. The rotary press further comprises at least one upper pressing device and at least one lower pressing device that, during operation, interact with the upper press punches and the lower press punches such that they press the filling material in the cavities of the die plate. An ejection device is further included in which the pellets generated in the cavities are ejected from the rotary press.

The invention also relates to a method for setting up and/or operating such a rotary press.

In rotary presses, the filling material to be pressed is filled into, dosed to, and/or pre-compressed in the cavities of the die plate by means of a filling device. A pellet is then generated in each cavity by the upper and lower punches. The quality of the produced pellets depends significantly on the quality of cavity filling. A reproducible cavity filling quality is therefore essential for a reproducible pellet quality. The cavity filling quality can for example be understood as the degree of fluctuation of the fill amounts in sequential cavities, and/or the density distribution of the filling material within a single cavity and/or sequential cavities. For example, a small fluctuation range of the fill amounts can ensure an even weight of all the produced pellets. This is an important quality feature according to the pharmacopoeia. For the cavity filling quality to be reproducible, a sufficient amount of filling material must in principle always be available for filling. Particularly during the filling phase in which filling material is filled into, dosed to and/or pre-compressed in the cavities, the availability of the filling material is relevant.

The availability of the filling material also depends on the filling material properties such as the flowability, moisture, etc. Whereas with many products, the cavities of the die plate can be overfilled slightly and then precisely dosed, pressed materials that flow poorly can cause bridging in the filling device so that subsequent pressed materials do not generate sufficient pressure.

All of the above makes it difficult and involved to set up a stable process. To date, this was accomplished based on the experience of the machine fitter. The setting up process is correspondingly time-consuming and cannot always be reliably reproduced given the dependence on the personal experience of the fitter. Changes during subsequent operation in comparison to the setting up process are not always reliably identified.

Proceeding from the described prior art, the object of the invention is therefore to provide a rotary press and a method of the above-cited type by means of which optimum filling of the cavities of the die plate is ensured in an easy and highly reliable manner.

### BRIEF SUMMARY OF THE INVENTION

With the rotary press of the aforementioned type, the invention achieves this object in that at least one measuring device is arranged on or in the filling device for monitoring the availability of the filling material in the filling device.

The rotary press according to the invention possesses a rotor in a manner known per se that can be rotated, for example, about a vertical axis by means of a rotary drive. The rotor comprises a die plate in which a plurality of cavities are arranged along a divided circle. A single pair of an upper punch and lower punch is assigned to each cavity of the die plate and rotates jointly therewith. During rotation, the upper punches and lower punches are moved in a manner known per se in an axial direction, such as by control cams. The upper punches of the rotor are guided axially in the upper punch guide, and the lower punches of the rotor are guided axially in the lower punch guide. The die plate of the rotary press according to the invention can be designed as a single piece, or composed of a plurality of ring segments. The cavities can be formed by holes created directly in the die plate, or by releasable dies inserted in the die plate.

The cavities are filled with filling material by the filling device. The filling material can be a powder. The filling device can for example comprise a filling chamber arranged above the die plate, such as in the form of a so-called filling shoe below which the die plate rotates. The filling material falls out of the filling chamber into the cavities under the assistance of gravity. By means of the at least one upper and one lower pressing device, the upper and lower punches are pressed against each other in the cavities, wherein the filling material is pressed in the cavities into a pellet, and in particular a tablet. Then the created pellets are generally expelled from the cavities by the lower punches and ejected from the rotary press by the ejection device. For this purpose, the ejection device can, for example, comprise a scraper that is arranged above the die plate below which the die plate rotates, and that scrapes off the pellets ejected from the cavities into a discharge channel. This is known per se.

According to the invention, at least one measuring device is arranged on or in the filling device and monitors the availability of the filling material in the filling device. Due to the at least one measuring device, the filling material availability can be monitored for consistent filling of the cavities of the die plate. “Filling material availability” is understood to be the continuous presence of a sufficient amount of filling material for uniformly filling the cavities. In particular, a sufficient availability of filling material ensures a uniform filling of the sequential cavities of the die plates so that the properties of the produced pellets, such as their pellet weight or the pressure expended for production, differ as little as possible from each other. According to the invention, measuring devices can detect the filling material availability at process-critical locations in the filling device, such as the filling chamber(s) of the filling device in which the filling material is transported to fill the cavities. This can accordingly ensure that a sufficient amount of filling material is always available.

Moreover, the optimum machine settings can be determined with the assistance of the least one measuring device when setting up the rotary press independent of the personal experience of an operator. During the subsequent production mode of the rotary press, any deviations from the required filling material availability can be quickly and reliably detected. Since the press can be set up with the assistance of measuring devices, and thus largely independent of the personal experience of an operator, the required time and costs can be reduced. The continuous monitoring of filling material availability enabled according to the invention during the setup phase and in subsequent production mode of the rotary press ensures an optimum and uniform quality of the filling of the die plate cavities, and hence the created pellets.

The at least one measuring device can in particular comprise an optical measuring device. Optical measuring devices are distinguished in this specific application by being very practical, economical and highly precise. Alternatively or in addition, other measuring devices are also conceivable such as acoustic measuring devices, capacitative measuring devices, piezoelectric measuring devices, resistive measuring devices such as strain gauges, electromagnetic measuring devices, and other pressure measuring devices, or any combination thereof.

The at least one measuring device can in particular be at least a distance measuring device that determines the distance to the surface of the filling material bed in the filling device, and determines the fill level therefrom.

According to another embodiment, at least one measuring device can be arranged in the filling device and measure the fill level of the filling material in a filling chamber of the filling device arranged directly above the die plate. In addition, the at least one measuring device can be an optical distance measuring device arranged at a specific position in the filling device, wherein measuring radiation emitted by the optical distance measuring device is directed toward the surface of the filling material in the filling chamber, and wherein the optical distance measuring device measures the distance to the surface of the filling material using measuring radiation reflected by the surface of the filling material and determines the fill level of the filling material in the filling chamber therefrom. During operation, the die plate rotates below the filling chamber, where the cavities are filled through an opening in the filling chamber with the assistance of gravity. In this filling chamber, the optical distance measuring device measures in particular its distance to the surface of the filling material and determines the fill level of the filling material therefrom. The optical distance measuring device can for example comprise a laser. The distance can be determined by the optical distance measuring device arranged in a specific installation position in the filling device for example by measuring the runtime of the emitted optical measuring radiation received after being reflected from the surface of the filling material. It is, however, also possible to ascertain the distance from a phase shift of the measuring radiation reflected from the surface of the material bed, or to determine the distance using the measuring radiation reflected from the surface of the material bed by means of a triangulation method. The optical measuring radiation emitted by the optical distance measuring device toward the filling material can for example be directed perpendicular to the surface of the filling material bed or at an angle to the surface of the filling material bed. The distance measuring device can determine the distance and hence the height of the filling material bed in the filling chamber, for example, at regular intervals or continuously.

According to another embodiment, at least one rotatably driven stirring impeller can be arranged in the filling chamber of the filling device which stirs the filling material located in the filling chamber when the rotary press is operating, wherein the optical distance measuring device is arranged above the at least one stirring impeller so that measuring radiation emitted by the optical distance measuring device passes between the stirrer blades of the stirring impeller onto the surface of the filling material, and measuring radiation reflected by the surface of the filling material passes back between the stirrer blades of the stirring impeller to the optical distance measuring device. The stirring impeller possesses a plurality of stirrer blades. It rotates in the material bed consisting of filling material and thereby ensures an effective transportation and loosening of the filling material. This is known per se. In this embodiment, the measuring axis of the distance measuring device along which the optical measuring radiation is emitted is interrupted at regular intervals by the stirrer blades of the stirring impeller. In this embodiment, the distance is measured between the stirrer blades, i.e., when the optical measuring axis is not interrupted by the stirrer blades.

At least one additional measuring device can be arranged in the filling device and measure the fill level of the filling material in a second filling chamber arranged above or to the side of the (first) filling chamber arranged directly above the die plate. The second filling chamber can for example also be arranged offset to the side above the first filling chamber. Of course, a third filling chamber could also be provided that is arranged above and possibly also offset to the side of the second filling chamber. Additional filling chambers are also conceivable. Pre-compression and/or dosing of the filling material, i.e., an adjustment of the fill amount, can occur in the filling chambers, in particular the second and/or possibly other filling chambers that are provided.

Moreover, the at least one other measuring device can be another optical distance measuring device arranged at a specific position in the filling device, wherein measuring radiation emitted by the other optical distance measuring device is directed toward the surface of the filling material in the second filling chamber, and wherein the other optical distance measuring device measures the distance to the surface of the filling material using the measuring radiation that is reflected by the surface of the filling material and determines the fill level of the filling material in the second filling chamber therefrom.

In addition, at least one rotatably driven stirring impeller can be arranged in the second filling chamber of the filling device which stirs the filling material located in the second filling chamber when the rotary press is operating, wherein the other optical distance measuring device is arranged above the at least one stirring impeller so that measuring radiation emitted by the other optical distance measuring device passes between the stirrer blades of the stirring impeller onto the surface of the filling material, and measuring radiation reflected by the surface of the filling material passes back between the stirrer blades of the stirring impeller to the other optical distance measuring device.

The embodiments explained with reference to the measuring device measuring the fill level of filling material in the first filling chamber can correspondingly also be provided with regard to the other measuring device measuring the fill level in the second filling chamber.

According to another embodiment, at least one measuring device can be provided that measures the fill level of the filling material in a supply section of the filling device. The filling material is supplied through the supply section to a second filling chamber, and/or a first filling chamber of the filling device. In addition, the at least one other measuring device can be (another) optical distance measuring device arranged at a specific position in the filling device, wherein measuring radiation emitted by the (other) optical distance measuring device is directed toward the surface of the filling material in the supply section, and wherein the (other) optical distance measuring device measures the distance to the surface of the filling material using the measuring radiation that is reflected by the surface of the filling material and determines the fill level of the filling material in the supply section therefrom.

According to another embodiment, the rotary press according to the invention can comprise display means that display the measured data of the at least one measuring device during a setup process of the rotary press, and/or during production mode of the rotary press. The display means can comprise a corresponding display. An operator can thereby monitor the production process. Of course, the measured data for the display can already be processed by the display means. Accordingly for example, the fill level in the filling device can be visualized, in particular in a supply section and/or in a filling chamber. If there are impermissible deviations from a specified set points, a warning signal can be emitted, e.g., visually and/or acoustically. The rotary press can also be stopped.

The rotary press according to the invention can furthermore comprise a control device to which the measured data of the at least one measuring device are applied, and that controls operating parameters of the rotary press during a setup process of the rotary press, and/or during production mode of the rotary press, based on the measured data. The control device can control the operating parameters of the rotary press during a rotary press setup process, and/or during the production mode of the rotary press, in particular so that a target amount of filling material is in the filling device.

Correspondingly, the invention also achieves the object by means of a method for setting up and/or operating a rotary press according to the invention in which operating parameters of the rotary press are controlled so that a target amount of filling material is in the filling device based on measured data of the at least one measuring device during a rotary press setup process, and/or during the production mode of the rotary press.

The control device can for example control the rotary speed of the rotor and/or the rotary speed of a stirring impeller of the filling device, and/or the amount of filling material supplied to the filling device. As mentioned above, the rotary speed of the rotor affects the availability of the filling material.

According to the invention, automated control in particular can be carried out based on the measured data of the at least one measuring device so that the optimum amount of filling material is always available, and a stable production process is accordingly ensured with pellets generated with reproducible high-quality. Suitable computer-supported control algorithms can be implemented in the control device for this. An optimum production process is thereby always ensured independent of the personal experience of an operator.

### BRIEF DESCRIPTION OF THE DRAWINGS

An exemplary embodiment of the invention is explained in greater detail below with reference to figures. Schematically,

FIG. 1 illustrates a portion of an embodiment of a rotary press,

FIG. 2 illustrates a top plan of a stirring impeller of the embodiment of the rotary press of FIG. 1, and

FIG. 3 illustrates a front plan view of a measuring device of the embodiment of the rotary press of FIG. 1.

The same reference numbers refer to the same objects in the figures unless indicated otherwise.

### DETAILED DESCRIPTION OF THE INVENTION

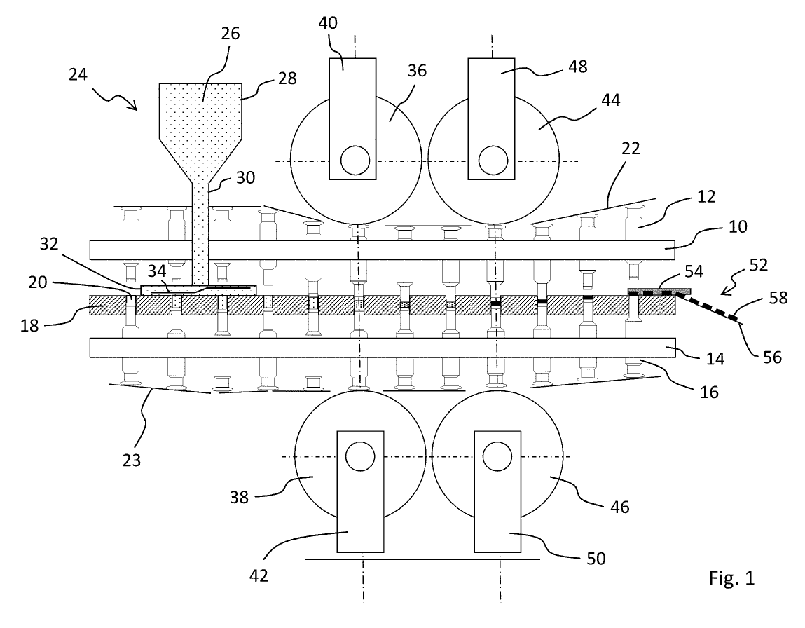

The rotary press shown in FIG. 1 comprises a rotor in a manner known per se that can be rotated for example about a vertical axis by means of a rotary drive (not shown in detail). The rotor comprises an upper punch guide 10 for a plurality of upper press punches 12, and/or a punch guide 14 for a plurality of lower press punches 16. Moreover, the rotor comprises a die plate 18 in which a plurality of holes or cavities 20 are formed. A single pair of an upper punch and lower punch 12, 16 is assigned to a cavity 20 of the die plate 18 and rotates jointly with the die plate 18. While rotating, the upper punches 12 and lower punches 16 are moved axially, in particular by means of upper control cams 22 and lower control cams 23. Moreover, the rotary press comprises a filling device 24 by means of which powdered filling material 26 is supplied in the depicted example to the cavities 20 of the die plate 18 rotating below the filling device 24. For this, the filling device 24 comprises a supply section with a filling funnel 28, and a supply tube 30 through which the filling material 26 is supplied to a filling chamber 32 designed in the form of a filling shoe. A rotatably driven stirring impeller 34 is located in the filling chamber 32 in the depicted example. Of course, other filling chambers can also be provided in which a stirring impeller may also rotate.

The rotary press furthermore comprises an upper pre-pressing device with an upper pre-pressing roller 36, and a lower pre-pressing device with a lower pre-pressing roller 38. The upper pre-pressing roller 36 is mounted on an upper pressing roller holder 40, and the lower pre-pressing roller 38 is mounted on a lower pressing roller holder 42. Moreover, an upper main pressing device with an upper main pressing roller 44 and a lower main pressing device with a lower main pressing roller 46 are provided. The upper main pressing roller 44 is mounted on an upper pressing roller holder 48, and the lower main pressing roller 46 is mounted on a lower pressing roller holder 50. Moreover, the rotary press according to the invention comprises an ejection device 52 with a scraper 54 arranged above the die plate 18 and a discharge channel 56.

During operation, the filling device 24 fills the holes 20 in the die plate 18 with filling material 26 under gravity in a manner known per se. The bottom sides of the holes 20 are closed at this time by the lower punches 16. In the region of the pre-pressing rollers 36 and 38, the filling material 26 is pre-pressed in the cavities 20 by the upper and bottom punches 12, 16. In the region of the main pressing rollers 44 and 46, the main pressing of the filling material 26 in the cavities 20 into pellets 58, in particular tablets 58, is carried out by the upper and bottom punches 12, 16. Then, the upper punches 12 leave the cavities 20, and the produced tablets 58 are ejected by the lower punches 16 out of the cavities 20 and are supplied by the scraper 54 to the discharge channel 56.

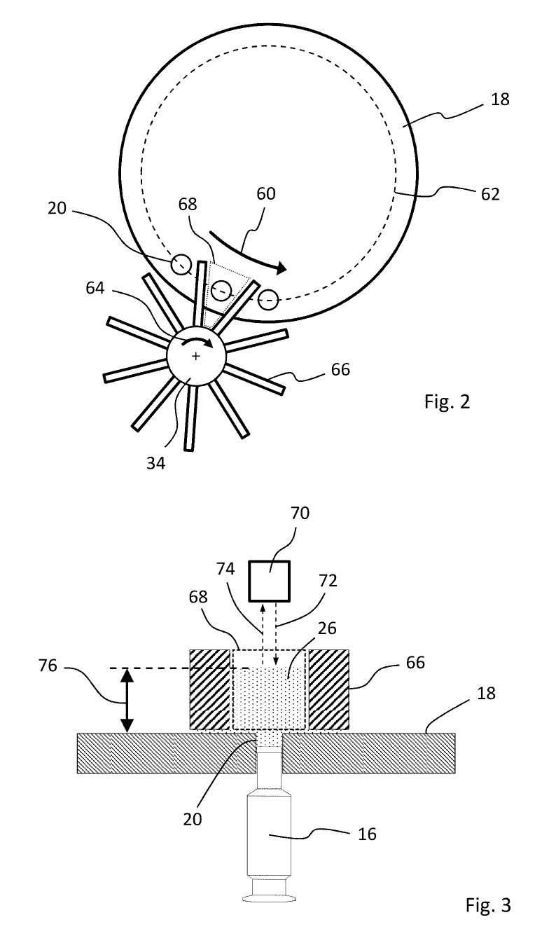

In the plan view in FIG. 2, the direction of rotation 60 of the die plate 18 is indicated by the arrow 60. The divided circle on which the cavities 20 of the die plate 18 are arranged (of which only three are depicted in FIG. 2 for reasons of clarity), is depicted in a dashed line at reference sign 62. In the illustration in FIG. 2, the stirring impeller 34 of the filling device 24 can be seen in greater detail. On one hand, the direction of rotation of the stirring impeller 34 is illustrated as an example by the arrow 64. The direction of rotation of the stirring impeller 64 and/or the direction of rotation 60 may also in principle be opposite. On the other hand, a plurality of stirrer blades of the stirring impeller 34 can be seen at reference sign 66. The cavities 20 are filled with filling material 26 in the region depicted with a dashed line in FIGS. 2 and 3 at reference sign 68.

A measuring device according to the invention is shown at reference sign 70 in FIG. 3. The measuring device 70 in the present example is an optical distance measuring device 70 arranged at a specific position in the filling device 24, such as a laser distance measuring device. The distance measuring device 70 emits optical measuring radiation from above toward the surface of the filling material 26 as shown in FIG. 3 at reference sign 72. The measuring radiation is reflected by the surface of the filling material 26 and returns to the distance measuring device 70 as shown in FIG. 3 at reference sign 74. For example, the distance measuring device 70 determines its distance from the surface of the filling material 26 by using a runtime measurement and from that, determines the fill level 76 of the filling device 24 of the filling material 26 in the filling chamber 32 of the filling device 24. As can be discerned in FIG. 3, the distance measuring device 70 is arranged above the stirring impeller 34 so that the measuring radiation emitted by the distance measuring device 70 passes between the stirrer blades 66 that regularly interrupt the measuring path, reaches the surface of the filling material 26, and returns to the distance measuring device 70 after being reflected.

The measuring data for measuring device 70 can be fed to a control device (not shown in detail) of the rotary press. Based on the measured data, the control device can control operating parameters of the rotary press during a rotary press setup process, and/or during the production mode of the rotary press, so that a target amount of filling material 26 is always in the filling device 24. For this, the control device can for example control the rotary speed of the rotor of the rotary press, and/or the rotary speed of the stirring impeller 34 of the filling device 24 as operating parameters. In addition, the rotary press can comprise display means (not shown in detail) that display the measured data of the measuring device 70 for an operator during a setup process of the rotary press, and/or during production mode of the rotary press.

### REFERENCE NUMBER LIST

10 Upper punch guide

12 Upper press punches

14 Lower punch guide

16 Lower press punches

18 Die plate

20 Cavities

22 Upper control cams

23 Lower control cams

24 Filling device

26 Filling material

28 Filling funnel

30 Supply tube

32 Filling chamber

34 Stirrer impeller

36 Upper pre-pressing roller

38 Lower pre-pressing roller

40 Upper pressing roller holder

42 Lower pressing roller holder

44 Upper main pressing roller

46 Lower main pressing roller

48 Upper pressing roller holder

50 Lower pressing roller holder

52 Ejection device

54 Scraper

56 Discharge channel

58 Pellets, tablets

60 Arrow

62 Divided circle

64 Arrow

66 Stirrer blade

68 Region

70 Distance measuring device

72 Measuring radiation

74 Measuring radiation

1. A rotary press comprising:
upper press punches and lower press punches;
a rotor configured to be rotated by a rotary drive, wherein the rotor comprises
an upper punch guide for the upper press punches,
a lower punch guide for the lower press punches, and
a die plate disposed between the upper and lower punch guides, wherein the upper and lower press punches are configured to interact with cavities of the die plate;
a filling device configured to load filling material into the cavities of the die plate;
at least one upper pressing device and at least one lower pressing device configured to interact with the upper press punches and the lower press punches during operation such that they press the filling material into the cavities of the die plate to produce pellets;
an ejection device configured to eject the pellets from the rotary press; and
at least one measuring device coupled to the filling device and configured to monitor availability of filling material in the filling device.

2. The rotary press according to claim 1, wherein the at least one measuring device comprises an optical measuring device.

3. The rotary press according to claim 1, wherein the at least one measuring device is disposed in the filling device and configured to measure a fill level of the filling material in a filling chamber of the filling device that is disposed directly above the die plate.

4. The rotary press according to claim 3, wherein the at least one measuring device is an optical distance measuring device disposed at a specific position in the filling device, wherein the optical distance measuring device is configured to emit measuring radiation directed toward a surface of the filling material of the filling chamber, and wherein the optical distance measuring device is further configured to measure a distance to the surface of the filling material using measuring radiation reflected by the surface of the filling material to determine a fill level of the filling material in the filling chamber therefrom.

5. The rotary press according to claim 4, further comprising at least one rotatably driven stirring impeller with a plurality of stirrer blades disposed in the filling chamber of the filling device that is configured to stir the filling material in the filling chamber during operation, wherein the optical distance measuring device is disposed above the at least one stirring impeller and configured to emit measuring radiation which passes between the plurality of stirrer blades of the at least one stirring impeller and onto the surface of the filling material, and wherein the optical distance measuring device is further configured to receive measuring radiation reflected by the surface of the filling material which passes back between the plurality of stirrer blades of the rotatably driven stirring impeller.

6. The rotary press according to claim 3, further comprising at least one other measuring device arranged in the filling device and configured to measure a fill level of filling material in a second filling chamber disposed above or to a side of the filling chamber of the filling device.

7. The rotary press according to claim 6, wherein the at least one other measuring device is a second optical distance measuring device disposed at a specific position in the filling device, the second optical distance measuring device is configured to emit measuring radiation directed toward a surface of the filling material in the second filling chamber, and wherein the second optical distance measuring device is further configured to measure a distance to a surface of the filling material in the second filling chamber using measuring radiation reflected by the surface of the filling material in the second filling chamber and is configured to determine a fill level of the filling material in the second filling chamber therefrom.

8. The rotary press according to claim 7, further comprising at least one rotatably driven stirring impeller including a plurality of stirrer blades disposed in the second filling chamber of the filling device and configured to stir the filling material located in the second filling chamber during operation, wherein the second optical distance measuring device is disposed above the at least one rotatably driven stirring impeller and configured to emit measuring radiation which passes between the plurality of stirrer blades of the at least one rotatably driven stirring impeller and onto the surface of the filling material in the second filling chamber, and wherein the second optical distance measuring device is configured to receive measuring radiation reflected by the surface of the filling material in the second filling chamber which passes back between the plurality of stirrer blades.

9. The rotary press according to claim 3, wherein the at least one measuring device is configured to measure the fill level of the filling material in a supply section of the filling device, and wherein the supply section of the filling device is configured to supply filling material to the filling chamber of the filling device.

10. The rotary press according to claim 1, further comprising a display means configured to display measured data of the at least one measuring device during a setup process of the rotary press and during production mode of the rotary press.

11. The rotary press according to claim 10, further comprising a control device configured to receive the measured data of the at least one measuring device and configured to control operating parameters of the rotary press during the setup process and during production mode of the rotary press.

12. The rotary press according to claim 11, wherein the control device is configured to control operating parameters of the rotary press during the setup process of the rotary press, and during the production mode of the rotary press so that a target amount of filling material is available in the filling device.

13. The rotary press according to claim 12, wherein the control device is configured to control a rotary speed of the rotor, and a rotary speed of a stirring impeller of the filling device, and an amount of filling material supplied to the filling device as operating parameters of the rotary press.

14. The rotary press according to claim 13, wherein the control device is configured to control the operating parameters of the rotary press so that the target amount of filling material is available in the filling device based on measured data of the at least one measuring device during the setup process and during the production mode of the rotary press.

15. The rotary press according to claim 13, wherein the rotary speed of the rotor, and the rotary speed of a stirring impeller of the filling device, and an amount of filling material supplied to the filling device are configured to be controlled as operating parameters of the rotary press.
